(19) United States
(12) Patent Application Publication
(10) Pub. No.: US 2023/0060908 A1
(43) Pub. Date: Mar. 2, 2023

(54) COMPUTER SYSTEM AND METHOD FOR BOOTING UP THE COMPUTER SYSTEM

(71) Applicant: Xunmu Information Technology (Shanghai) Co., Ltd., Shanghai (CN)

(72) Inventor: Jiang WANG, Shanghai (CN)

(73) Assignee: Xunmu Information Technology (Shanghai) Co., Ltd., Shanghai (CN)

(21) Appl. No.: 17/890,865

(22) Filed: Aug. 18, 2022

(30) Foreign Application Priority Data
Aug. 30, 2021 (CN) 202111001644.9

(51) Int. Cl. G06F 9/4401; G06F 9/445; G06F 8/65

(52) U.S. Cl. CPC G06F 9/4401; G06F 9/44505; G06F 8/65

(57) ABSTRACT

A computer system and a method for booting up the computer system. In the computer system, a first memory device stores a first firmware, and a second memory device stores a second firmware. A programmable device is connected to the first memory device and the second memory device, comprising a selector device and a monitor circuit. The selector device provides a path switch function for selecting the first memory device or the second memory device as the selected firmware. The computer system has a processor connected with the programmable device, which can load and execute the selected firmware according to the path switch function. When the computer system is powered on, the monitor circuit determines whether the processor successfully loads and executes the selected firmware. If unsuccessful, the monitor circuit changes the path switch function to load and execute an alternatively selected firmware after the processor is reset.

### CROSS REFERENCE TO RELATED APPLICATION

This application claims the priority benefit of Chinese Patent Application Serial Number 202111001644.9, filed on Aug. 30, 2021, the full disclosure of which is incorporated herein by reference.

### BACKGROUND

### Technical Field

The present application relates to a computer system and a method for booting up the computer system, and particularly, to a method for ensuring that the computer system can successfully load and execute firmware to start an operation system.

### Related Art

In most medium-end and high-end computer systems, the firmware for booting is stored in external nonvolatile memory device, such as a flash memory device. When the computer system is powered on or rebooted, a processor therein reads the firmware from the flash memory device for booting up the computer system.

FIG. 1 is an architecture diagram of a computer system 100 in a known technology. The computer system 100 includes a processor 110 connected to the memory device 120 through a circuit path 102. The memory device 120 stores a firmware (not shown). When the computer system 100 is powered on, the processor 110 reads the firmware for booting from the memory device 120 statically through the circuit path 102. Sometimes the firmware for booting needs to be upgraded due to bug fix or function addition. The computer system 100 can obtain a new version firmware through an external interface such as a network port (not shown), and perform an online upgrade through the circuit path 102 with the memory device 120. During the process, if the upgrade fails due to power failure, system abnormality, software defect and/or other reasons, the firmware in the memory device 120 is incomplete and un-executable, causing the computer system 100 to lose function.

To avoid the catastrophic event of system paralysis caused by the failure of firmware upgrade, an existing firmware backup scheme is to configure two pieces of flash memory device in the computer system. That is, the computer system has a motherboard, a processor and two pieces of flash memory devices, wherein the processor and the two pieces of flash memory devices are deployed on the motherboard. The motherboard is provided with a switch line and a jumper cap. The switch line is connected between the processor and the two flash memory devices. The jumper cap is pluggable on the motherboard and connected to the switch line. Change of the position of the jumper cap can change the configuration of the switch line, so that the processor can be electrically connected to one of the two flash memory devices through the switch line. When the firmware upgrade fails, the flash memory device may be unworkable. In that case, the user can change the position of the jumper cap by pulling and inserting the jumper cap, so that the processor can be booted up through another flash memory device. The computer system is therefore operated in a recovery mode, allowing the failed flash memory device to be upgraded again. The jumper cap can be replaced with a manual switch, serving as an alternative way to use the backup firmware.

The disadvantages of the above two implementation schemes are as follows.

The computer system 100 described in FIG. 1 does not consider how to automatically boot with the backup firmware. If the upgrade fails, the computer system casing must be opened to perform a manually switching. On the other hand, recovery of the firmware requires an emulator or other auxiliary tools, wherein the memory device 120 must be moved out of the computer system 100 for a burn-in procedure. The operation is extremely inconvenient and is not suitable for remote operations and/or onsite operations in the server room. The method for booting up with a backup firmware in the two-flash-memory-device architecture not only requires manual intervention of operators, but also unsuitable for remote operations or onsite operations in the server room. The operator is required to be familiar with the chip position, jumper cap or manual switch position, therefore both methods are not user-friendly. Furthermore, since a manual operation is required, the efficiencies of the two recovery methods are relatively low, taking long system downtime.

### SUMMARY

It should be understood, however, that this summary may not contain all aspects and embodiments of the present invention, that this summary is not meant to be limiting or restrictive in any manner, and that the invention as disclosed herein may be understood by one of ordinary skill in the art to encompass obvious improvements and modifications thereto.

To solve the aforementioned technical problems, the embodiment of the present application provides a method and a computer system implementing the method to ensure a successful boot operation.

In one embodiment of the computer system, at least the following components are included. A first memory device is configured to store a first firmware. A second memory device is configured to store a second firmware. A programmable device is connected to the first memory device and the second memory device, comprising a selector device. The selector device provides a path switch function for selecting one of the first firmware of the first memory device and the second firmware of the second memory device as a selected firmware. A processor connected with the programmable device may load the selected firmware according to the path switch function, and execute the selected firmware. When the computer system is powered on, the programmable device may determine whether the processor successfully loads and executes the selected firmware. If the processor fails loading or executing the selected firmware, the programmable device may perform the path switch function to select an alternative firmware from the first firmware of the first memory device and the second firmware of the second memory device as the selected firmware, which may cause the processor to load and execute the alternative firmware after reset.

In a specific embodiment, the programmable device also includes a monitor circuit, and the programmable device is configured to determine whether the processor successfully loads and executes the selected firmware through the monitor circuit. When the computer system is powered on, the monitor circuit may start a timer. When the monitor circuit sends an overflow signal indicating that the timer is overflow, the programmable device may determine that the processor fails loading or executing the selected firmware.

In a specific embodiment, the processor and the programmable device can be connected through an inter integrated chip (I2C) bus.

In one embodiment, the processor may comprise a reset pin, adaptable for triggering the processor to reset. The reset pin is exclusively connected to the programmable device. When the programmable device receives or generates a reset signal, the programmable device may transmit the reset signal through the reset pin to reset the processor.

In a specific embodiment, after the processor successfully loads and executes the selected firmware, the monitor circuit can be switched off through the programmable device, and then the operating system and application software can be loaded.

In a specific embodiment, the programmable device may be a complex programmable logic device (CPLD).

In a specific embodiment, the selector device is a chip selectable circuit, and the path switch function may be a chip select signal.

In one embodiment, the second firmware of the second memory device is configured by default as the selected firmware. When the computer system performs firmware upgrade, the selector device is configured to select the second memory device by default to allow the processor to upgrade the second firmware. When the second firmware upgrade is completed, the processor is reset to load and execute the second firmware. When the programmable device determines that the processor fails loading or executing the second firmware, the selector device performs the path switch function to select the first memory device for the processor to load and execute the first firmware after reset.

In a further embodiment, the programmable device provides a function of recording the failure, so that the computer system knows the previous update failure after reset, and then decides whether to restore the firmware. For example, when the programmable device determines that the processor fails loading or executing the second firmware, a failure signal is generated, allowing the processor after reset to trigger a program according to the failure signal to restore the second firmware.

Another embodiment of the present application is a method for booting up a computer system applied to the computer system, which can ensure the processor in the computer system to successfully load and execute a firmware. The method for booting up a computer system can be summarized as the following steps. A first firmware is provided in the first memory device and a second firmware is provided in the second memory device. A path switch function is performed for selecting one of the first firmware of the first memory device and the second firmware of the second memory device as a selected firmware. The selected firmware selected by the path switch function, is loaded for execution. When the computer system is powered on, it is determined whether the selected firmware is successfully loaded and executed. When the computer system fails loading or executing the selected firmware, the path switch function is performed to select an alternative one of the first firmware of the first memory device and the second firmware of the second memory device as the selected firmware, so that the alternatively selected firmware is loaded for execution after the computer system is rebooted.

In a specific embodiment, when the computer system is powered on, the monitor circuit can determine whether the selected firmware is successfully loaded and executed. The monitor circuit can start a timer. When the timer overflows, the monitor circuit sends an overflow signal to indicate that the processor fails loading or executing the selected firmware.

In a specific embodiment, when it is determined that the selected firmware is successfully loaded and executed, the monitor circuit can be switched off, and thereafter, the operating system and application software can be loaded.

In a specific embodiment, the path switch function may be implemented by sending a chip selection signal.

In a specific embodiment, the second firmware of the second memory device is selected by default as the selected firmware, and when the computer system is upgraded, the second firmware is upgraded by default. When the second firmware is upgraded, the computer system is rebooted to load and execute the second firmware.

When the computer system is determined failing to load or execute the second firmware, the path switch function is performed to select the first memory device, allowing the first firmware to be loaded and executed after the computer system is rebooted.

Compared with the conventional method for booting up from a backup firmware, the application has obvious advantages as follows.

The use of the programmable device eliminates the problem of on-site works on disassembling and assembling the computer systems. A remote support is provided as a backup for firmware update failure. Even if the update fails, the computer system remains bootable for subsequent restoration and repair. The above features allow the upgrade and repair processes to be performed remotely. If the upgraded firmware fails to be loaded or executed, the operator can run a remote recovery without onsite works on switching the jumper caps or switches using sophisticated tools. The proposed embodiments are easy to operate and significantly efficient in time, manpower and material resources. Furthermore, the embodiments of the application improve the reliability of the computer system. If the firmware upgrade fails, the computer system can be automatically booted up from a backup firmware without manual intervention. The occurrence of catastrophic events caused by the failure of the computer system can be efficiently avoided.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a computer system architecture in a known technology;

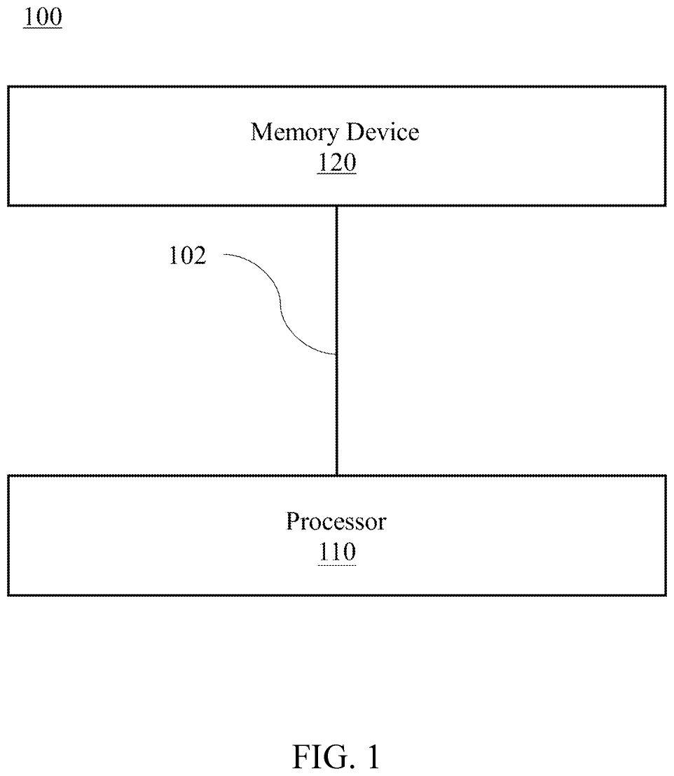

FIG. 2 shows a computer system architecture according to an embodiment of the present application;

FIG. 3 shows a computer system architecture according to another embodiment of the present application; and

FIG. 4 is a flowchart of a method for booting up a computer system according to an embodiment of the present application.

### DETAILED DESCRIPTION OF THE EMBODIMENTS

The present invention may now be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that this present invention may be thorough and complete, and may fully convey the scope of the present invention to those skilled in the art.

Certain terms are used throughout the description and following claims to refer to particular components. As one skilled in the art may appreciate, manufacturers may refer to a component by different names. This document does not intend to distinguish between components that differ in name but function. In the following description and in the claims, the terms “include/comprising” and “comprise/comprising” are used in an open-ended fashion, and thus should be interpreted as “comprising but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

The technical scheme in the embodiment of the application may be clearly and completely described below in combination with the accompanying drawings in the embodiment of the application. Obviously, the described embodiments are part of the embodiments of the application, not all of the embodiments. Based on the embodiments in the application, all other embodiments obtained by those skilled in the art without creative work belong to the scope of protection of the application.

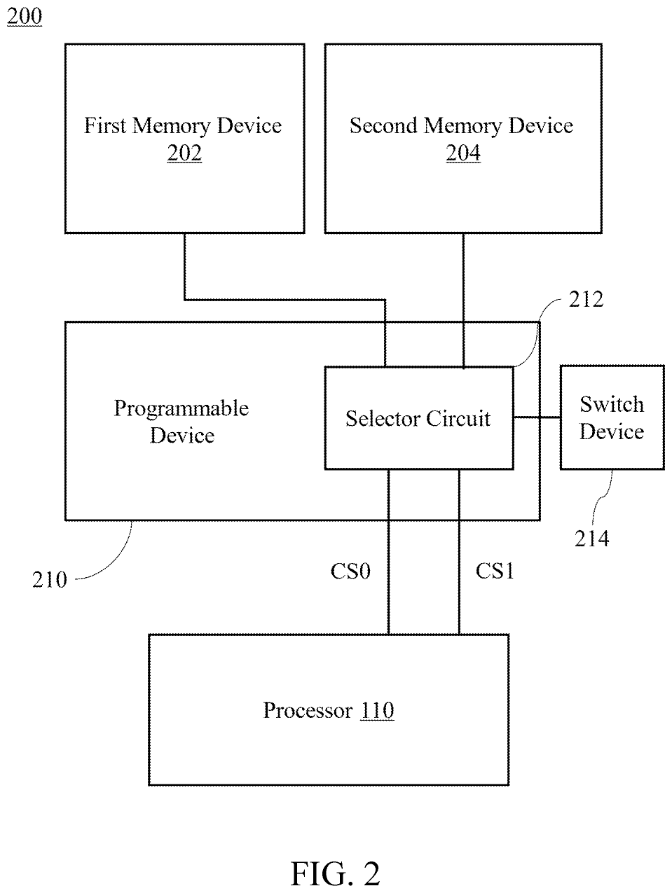

FIG. 2 shows a computer system architecture according to an embodiment of the present application. The computer system 200 includes a processor, a programmable device 210, a first memory device 202 and a second memory device 204. The programmable device 210 is, for example, but not limited to, a complex programmable logic device (CPLD). The first memory device 202 and the second memory device 204, for example, may be, but not limited to, two pieces of flash memory devices. The programmable device 210 includes a selector device 212. The first memory device 202 and the second memory device 204 are connected to the selector device 212. The first memory device 202 and the second memory device 204 are further connected with the processor 110 through the programmable device 210. The programmable device 210 can switch the selector device 212 to connect the first memory device 202 or the second memory device 204 according to a switching signal. In this architecture, the switching signal for the first memory device 202 and the second memory device 204 is processed by the programmable device 210, while other signals of the first memory device 202 and the second memory device 204 are directly connected to the processor 110. The switching of the selector device 212 may be, for example, but is not limited to, controlled by an external switch device 214. In some embodiments, the switch device 214 may also be an integrated programmable device 210. The switch device 214 may generate a corresponding switching signal through an external input signal, or may generate a corresponding switching signal through the control of the processor 110. In some embodiments, the switch device 214 is integrated into the programmable device 210. The programmable device 210 may select a different flash memory device to boot up the computer system 200 through the switch device 214, and then upgrade the failed flash memory device again to restore the computer system. For example, under certain conditions, the selector device 212 may cause the processor 110 to be connected to the first memory device 202, wherein the firmware for booting is read from the first memory device 202, such that the processor 110 loads and executes the firmware to boot up the computer system 200. When upgrading the firmware, the firmware in the first memory device 202 may be upgraded by default. The programmable device 210 may be used to determine whether the firmware is successfully upgraded or written to the first memory device 202. That is, the integrity and correctness of the upgrade or write procedures are determined. The programmable device 210 may also be used to determine whether the processor 110 successfully loads or reads the firmware of the first memory device 202. That is, the integrity and correctness of data loaded or read by a program is determined. When the programmable device 210 determines that the firmware upgrade fails or the loading fails, the programmable device 210 employs the switch device 214 to cause the computer system 200 to reboot and load the firmware from the second memory device 204. In some embodiments, the switching of the selector device 212 is through a chip selection mechanism, such as a chip selectable switch circuit using a programmable logic device or a selector device.

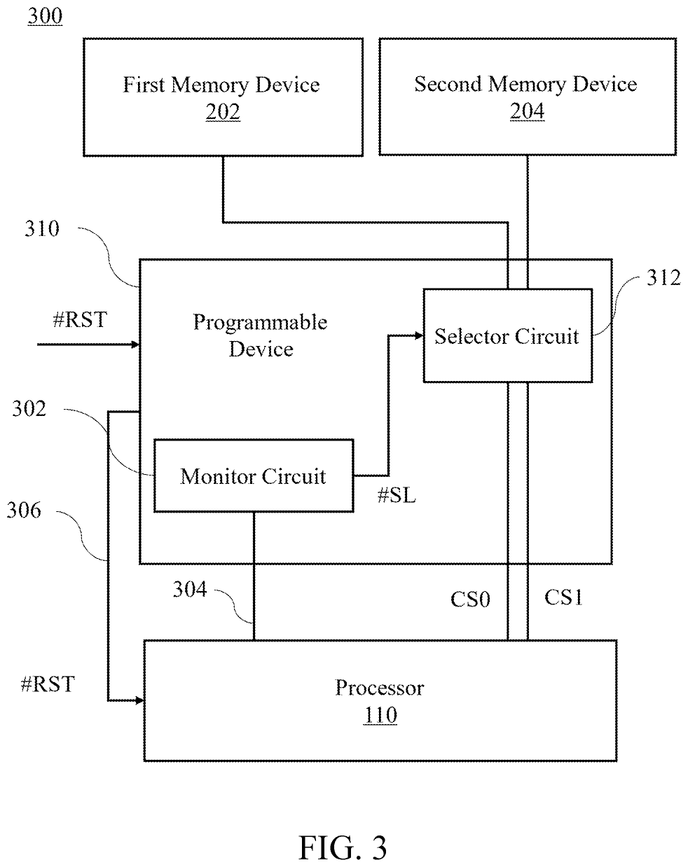

FIG. 3 shows a computer system architecture according to another embodiment of the present application. The embodiment implements a monitor circuit 302 in the programmable device 310. The monitor circuit 302 may be used to realize the functions of the aforementioned switch device. Through the logic design of the programmable device 310, the disadvantages in the conventional firmware backup schemes are overcome. The principle of operation of the monitor circuit 302 is similar to a watchdog mechanism, which can respond in real time according to the situation to flexibly realize the firmware selection mechanism.

The processor 110 and two flash memory devices, that is, the first memory device 202 and the second memory device 204, are connected through the programmable device 310. In the present embodiment, only the part where the programmable device 310 processes the chip selection channel of the first memory device 202 and the second memory device 204 is described. As for other signals of the first memory device 202 and the second memory device 204, they are mainly directly connected and processed by the processor 110, which is not otherwise described in this example. The programmable device 310 includes a selector device 312. The monitor circuit 302 in the programmable device 310 may be a signal generator with a timer. A default threshold of the timer in the monitor circuit 302 can be preset according to the time required to boot up the computer system. When the timer of the monitor circuit 302 exceeds the default threshold, the timer is overflow. A signal indicating the timer overflow can be generated, allowing the programmable device to acknowledge the situation that there is a firmware loading/execution failure, so as to trigger subsequent actions. For example, when the timer overflows, the monitor circuit 302 can directly output a chip selection signal #SL to the selector device 312 to make the selector device 312 switch the circuit paths from the first memory device 202 or the second memory device 204 toward the first channel CS0 and the second channel CS1. The monitor circuit 302 and the processor 110 are connected through a control bus 304 for the processor 110 to control the switching of the monitor circuit 302. If the processor 110 fails loading and/or executing the firmware and goes down, no signal may be transmitted through the control bus 304 to shut down the monitor circuit 302, and therefore the timer in the monitor circuit 302 goes overflow to trigger a chip selection signal #SL. After receiving the chip selection signal #SL, the selector device 312 switches the circuit paths of the first channel CS0 and the second channel CS1, causing the processor to access a different flash memory device.

In the present embodiment, the computer system 100 connects the first memory device 202 and the second memory device 204 through the first channel CS0 and the second channel CS1. Due to the general design limitations of the processor 110, the processor 110 at an initialization stage can only use the first channel CS0 to load the firmware. When the circuit paths of the first channel CS0 and the second channel CS1 pass through the programmable device 310, the selector device 312 is adaptable for realize the function of circuit path switching. For example, after the computer system 300 is powered on or reboot, the monitor circuit 302 can automatically start to connect first channel CS0 to the second memory device 204, and the second channel CS1 to the first memory device 202. After the timer overflow, the monitor circuit 302 can send a chip selection signal #SL to the selector device 312, causing the first channel CS0 to be connected to the first memory device 202 and the second channel CS1 to the second memory device 204.

Furthermore, in the programmable device 310 of the present embodiment, the reset signal originally used to reset the processor 110 may first be input to the programmable device 310, and then output to the processor 110 by control of the programmable device 310. Thus, the programmable device 310 can actively determine the timing ready to reset the processor 110, ensuring that the monitor circuit 302 and the selector device 312 have sufficient time to prepare the operating conditions required by the processor 110.

To sum up, in the specific embodiment of the computer system 300 in FIG. 3, at least the following components are used. First, the first memory device 202 is adaptable for storing the first firmware, and the second memory device 204 stores the second firmware (not shown). A programmable device 310 is used in the computer system 300 to connect the first memory device 202 and the second memory device 204. The programmable device 310 includes a selector device 312 and a monitor circuit 302. The selector device 312 provides a path switch function for selecting the first memory device 202 or the second memory device 204 as the selected firmware. In the embodiment, the path switch function is a chip selection signal, that is, a selection implemented by generating a high/low level signal in a logic circuit. Thus, the computer system 300 does not need a physical switching mechanism or manual intervention.

The processor 110 is connected with the programmable device 310 and loads and executes the selected firmware through the path switch function of the selector device 312. When the computer system 300 is powered on, the monitor circuit 302 determines whether the processor 110 successfully loads and executes the selected firmware. If unsuccessful, the monitor circuit 302 changes the path switch function of the selector device 312 through the chip selection signal #SL, causing the processor 110 to reset and load and execute different selected firmware.

In one embodiment, when the computer system 300 is powered on, the monitor circuit 302 may start a timer. When the timer of the monitor circuit 302 overflows, or the processor 110 does not report a successful booting result within a predetermined time limit, the monitor circuit 302 deems that the processor 110 has failed loading or executing the selected firmware.

In one embodiment, the processor 110 and the programmable device 310 may be connected to each other through a control bus 304.

In a specific embodiment, the processor 110 may include a reset pin (not shown) for triggering the processor 110 to reset. The reset pin of the processor 110 is exclusively controlled by the programmable device 310 through a reset bus 306. When a reset signal #RST is generated in the computer system 300, the reset signal #RST is first received by the programmable device 310, and passed to the processor 110 through the reset bus 306 to trigger a processor reset. On the other hand, the programmable device 310 can also actively generate a reset signal #RST when there is a need to reset the processor 110, which is then sent to the processor 110 through the reset bus 306 to trigger the processor reset.

In one embodiment, when the processor 110 successfully loads and executes the selected firmware, the monitor circuit 302 can be switched off through the control bus 304. Another approach is that when the processor 110 successfully loads and executes the selected firmware, it returns a boot successful signal to the monitor circuit 302 through the control bus 304 to stop the timer in the monitor circuit 302, so as to avoid the timer overflow. After the monitor circuit 302 is turned off or stops timing, the processor 110 can continue to load the operating system and application software, allowing the computer system 300 to function normally.

In a specific embodiment, the programmable device 310 may be a complex programmable logic device (CPLD).

The architecture described in FIG. 3 is particularly suitable for applications where remote firmware upgrade is required. When the computer system 300 performs a firmware upgrade, the path switch function can be configured to connect the second memory device 204, causing the processor 110 to upgrade the second firmware. When the second firmware upgrade is completed, the processor 110 is reset to load and execute the second firmware. When the monitor circuit 302 determines that the processor 110 fails loading or executing the second firmware, the path switch function can be changed to connect the first memory device 202 for the processor 110 to load and execute the first firmware after reset.

In a further embodiment, the monitor circuit 302 provides a function of recording the failure, so that the computer system 300 knows that the previous update is failed after reset, and accordingly decides whether to restore the firmware. For example, when the monitor circuit 302 determines that the processor 110 fails loading or executing the second firmware, a failure signal may be generated. When the processor 110 is reset, it is booted up normally with the first firmware. Then, the failure signal is received from the monitor circuit 302 through the control bus 304 to know that the previous upgrade is failed. If a function of automatically restoring firmware is configured in the first firmware, it can be selectively triggered to restore the second firmware. The method of restore can be a clone operation to duplicate the first firmware from the first memory device to the second memory device, or a remote operation reading a file for recovery from another user-defined backup address and writing it to the second memory device.

The computer system 300 proposed in the present application may be any application device implemented based on the processor 110 and firmware, comprising but not limited to servers, switches, embedded systems, network monitors, network storage systems, or Internet of things devices. It is especially suitable for equipment that is difficult to be maintained manually and often needs remote control. Although not explicitly described in the embodiment of the application, the computer system 300 may include other components necessary for operation, such as communication module, network interface, man-machine interface, storage system, etc. The detailed functions and architecture are not within the scope of this application.

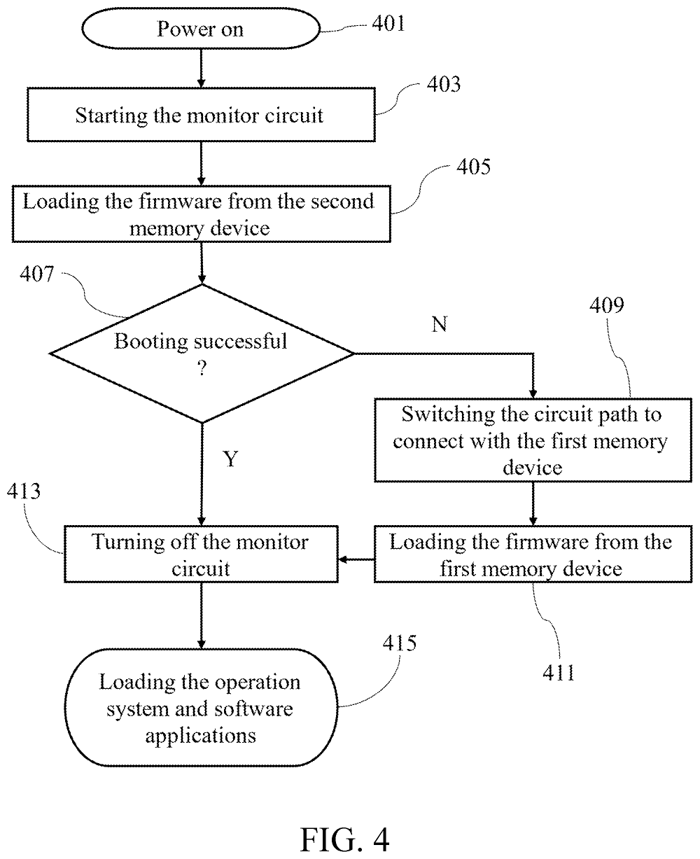

FIG. 4 is a flowchart of a computer system 300 boot up method according to an embodiment of the present application. Based on the computer system 300 of FIG. 3, the aforementioned embodiments can be summarized into the following steps. First, in step 401, the computer system 300 is powered on. In step 403, when the computer system 300 is powered on or rebooted, the programmable device 310 transmits a reset signal #RST to the processor 110 through the reset bus 306, and starts the monitor circuit 302 at the same time. In that case, the path switch function in the selector device 312 causes the first channel CS0 to be connected to the second memory device 204 and the second channel CS1 to be connected to the first memory device 202 according to default settings or custom settings. In step 405, the processor 110 reads and executes the firmware from the second memory device 204 to boot up the computer system. In step 407, it is determined whether the booting procedure is successful. In this embodiment, the determination of successful booting is basically a timer waiting process in the monitor circuit 302. If the computer system is successfully booted up, the monitor circuit 302 is turned off in step 413. Specifically, if the processor 110 successfully loads and executes the firmware, it may issue a command to switch off the monitor circuit 302 through the control bus 304, or issue a command to stop the timer in the monitor circuit 302. In contrast, if there is a problem with the execution state of the processor 110 after loading the firmware, the monitor circuit 302 may not receive any command, and finally a timer overflow occurs. When the timer overflows, it is determined that the processor 110 fails booting up the computer system using the firmware, and therefore the procedure goes to step 409.

In step 409, the booting procedure is determined failed due to the timer overflow in the monitor circuit 302. The monitor circuit 302 notifies the selector device 312 through a chip selection signal #SL to switch the circuit paths in the selector device 312. That is, the first channel CS0 is reconnected to the first memory device 202, and the second channel CS1 is reconnected to the second memory device 204. Meanwhile, the programmable device 310 outputs a reset signal #RST to the processor 110 through the reset bus 306, triggering the processor 110 to reset. In step 411, the processor 110 after reset reads and executes the firmware from the first memory device 202 through a circuit path selected by the selector device 312. When the processor 110 successfully loads and executes the first memory device 202, it proceeds to step 413 to turn off the monitor circuit 302. Thereafter, the processor 110 may proceed to step 415 to normally load an operating system and application software.

The method for booting up the computer system in the application can guarantee that the computer system 300 is fail safe especially when the computer system is upgraded. In one embodiment, when firmware upgrade is proceeded, the basic rule is to always update one memory device while the other one always maintains static. For example, a firmware upgrade is always performed on the second memory device 204. In this way, once the upgrade fails, the computer system 300 still maintains basic functionalities by using the firmware in the first memory device 202. Based on the maintained functionalities, the computer system 300 further retains the potential to recover the second memory device 204 or perform the upgrade on the second memory device 204 once more.

In some embodiments, the processor 110 and the programmable device 310 can be interconnected through an I2C bus to facilitate the computer system to read information such as the status of the monitor circuit 302 or the reason of booting. The computer system 300 also uses the I2C bus to switch off the monitor circuit 302. In an embodiment, the control bus 304 is an I2C bus. In some embodiments, the control bus 304 may also be an SPI bus or a parallel bus. In a further implementation, different kinds of buses can also be applied to realize the connection between the processor 110 and the programmable device 310.

In a further embodiment, whenever the computer system 300 is booted up successfully, the configuration of the selector device 312 can be stored as a default selection for next booting. The stored configuration can employ a nonvolatile storage device presented in the computer system 300, such as the remaining space in the first memory device 202 or the second memory device 204, or a nonvolatile storage built within the programmable device 310.

In a further embodiment, the overflow threshold of the timer in the monitor circuit 302 can be changed by software. For example, a configuration related to the overflow threshold can be stored in the programmable device 310, and when the monitor circuit 302 is turned on, the stored configuration can be instantly applied thereto.

In a further embodiment, the configuration of the selector device 312 may be adjustable not only by the chip selection signal #SL of the monitor circuit 302, but also by software.

Compared with the existing firmware flash backup scheme, the application has obvious advantages. Firstly, remote operation is supported. If the computer system fails to boot up after firmware upgrade, the operator is able to remotely recover the computer system without tools or onsite works such as switching the jumper caps or the switches. The maintenance is simplified, rendering significant efficiency improvements in time, manpower and material resources. Furthermore, the reliability of the computer system is improved. The computer system is able to automatically reboot from a backup firmware without manual intervention when a firmware upgrade operation is failed. The occurrence of catastrophic events caused by computer system failure can be avoided.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It may be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A computer system, comprising:
a first memory device configured to store a first firmware;
a second memory device configured to store a second firmware;
a programmable device connected to the first memory device and the second memory device, comprising a selector device; wherein:
the selector device provides a path switch function for selecting one of the first firmware of the first memory device and the second firmware of the second memory device as a selected firmware; and
a processor connected with the programmable device to load the selected firmware according to the path switch function, and execute the selected firmware;
when the computer system is powered on, the programmable device determines whether the processor successfully loads and executes the selected firmware;
if the processor fails loading or executing the selected firmware, the programmable device performs the path switch function to select an alternative firmware from the first firmware of the first memory device and the second firmware of the second memory device as the selected firmware, and causes the processor to load and execute the alternative firmware after reset.

2. The computer system as claimed in claim 1, wherein the programmable device further comprises a monitor circuit, and the programmable device is configured to determine whether the processor successfully loads and executes the selected firmware through the monitor circuit, wherein:
when the computer system is powered on, the monitor circuit starts a timer; and
when the monitor circuit sends an overflow signal indicating that the timer is overflow, the programmable device determines that the processor fails loading or executing the selected firmware.

3. The computer system as claimed in claim 2, wherein:
when the processor successfully loads and executes the selected firmware, the processor switches off the monitor circuit through a chip level bus, and then loads an operating system and application software.

4. The computer system as claimed in claim 1, wherein:
the processor comprises a reset pin, adaptable for triggering the processor to reset;
the reset pin is exclusively connected to the programmable device; and
when the programmable device receives or generates a reset signal, the programmable device transmits the reset signal through the reset pin to reset the processor.

5. The computer system as claimed in claim 1, wherein:
the selector device is a chip selectable circuit, and the path switch function is a chip selection signal.

6. The computer system as claimed in claim 1, wherein:
the second firmware of the second memory device is configured by default as the selected firmware;
when the computer system performs firmware upgrade, the selector device is configured to select the second memory device by default to allow the processor to upgrade the second firmware;
when the second firmware upgrade is completed, the processor is reset to load and execute the second firmware; and
when the programmable device determines that the processor fails loading or executing the second firmware, the selector device performs the path switch function to select the first memory device for the processor to load and execute the first firmware after reset.

7. The computer system as claimed in claim 6, wherein:
when the programmable device determines that the processor fails loading or executing the second firmware, a failure signal is generated, allowing the processor after reset to trigger a program according to the failure signal to restore the second firmware.

8. A method for booting up a computer system, comprising:
providing a first firmware in a first memory device;
providing a second firmware in a second memory device;
performing a path switch function for selecting one of the first firmware of the first memory device and the second firmware of the second memory device as a selected firmware;
loading the selected firmware selected by the path switch function for execution;
when the computer system is powered on, determining whether the selected firmware is successfully loaded and executed; and
when the computer system fails loading or executing the selected firmware, performing the path switch function to select an alternative one of the first firmware of the first memory device and the second firmware of the second memory device as the selected firmware, and loading the alternatively selected firmware for execution after resetting.

9. The method for booting up a computer system as claimed in claim 8, further comprising:
determining whether the selected firmware is successfully loaded and executed by the monitor circuit;
having the monitor circuit start a timer when the computer system is powered on; and
when the timer overflows, the monitor circuit sends an overflow signal;
wherein the overflow signal is adaptable for indicating whether the selected firmware is successfully loaded and executed.

10. The method for booting up a computer system as claimed in claim 9, further comprising:
when the selected firmware is determined successfully loaded and executed, switching off the monitor circuit, and then loading an operating system and application software.

11. The method for booting up a computer system as claimed in claim 9, wherein the path switch function comprises sending a chip selection signal.

12. The method for booting up a computer system as claimed in claim 9, further comprising:
selecting the second firmware of the second memory device by default as the selected firmware, and upgrading the second firmware by default when upgrading the computer system;
when the second firmware is upgraded, resetting to load and execute the second firmware; and
when the computer system is determined failing to load or execute the second firmware, performing the path switch function to select the first memory device, allowing the first firmware to be loaded and executed after resetting.

13. The method for booting up a computer system as claimed in claim 12, further comprising:
when the computer system is determined failing to load or execute the second firmware, generating a failure signal for triggering a program to restore the second firmware after resetting.
